(19) United States
(12) Patent Application Publication
(10) Pub. No.: US 2014/0090635 A1
(43) Pub. Date: Apr. 3, 2014

(54) PROPANE TANK FUEL GAUGE FOR BARBECUE GRILL

(71) Applicant: The Brinkmann Corporation, Dallas, TX (US)

(72) Inventor: Randall L. May, Plano, TX (US)

(73) Assignee: The Brinkmann Corporation, Dallas, TX (US)

(21) Appl. No.: 14/040,445

(22) Filed: Sep. 27, 2013

Related U.S. Application Data
(60) Provisional application No. 61/707,694, filed on Sep. 28, 2012.

(51) Int. Cl. G01F 23/20; A47J 37/07

(52) U.S. Cl. CPC G01F 23/20; A47J 37/0786
USPC 126/25 R; 73/296

(57) ABSTRACT

A propane tank fuel gauge for use with a barbecue grill that measures the weight of the tank and thereby provides a readily perceived indication of the amount of propane gas remaining therein. The fuel gauge comprises a base, a tank mount adapted for mounting a propane tank, a spring-loaded support mechanism for supporting the tank mount relative to the base, and a fuel level indicator connected to the support mechanism for providing an indication of the total weight of the tank including the propane gas remaining therein.

### CROSS-REFERENCE TO RELATED APPLICATION

This application claims the benefit of U.S. Provisional Application Ser. No. 61/707,694, filed Sep. 28, 2012, the entire contents of which are herein incorporated by reference as if fully set forth herein.

### BACKGROUND OF THE INVENTION

The present invention relates generally to outdoor barbecue grills, and more particularly to a propane tank fuel gauge or scale for use with outdoor barbecue grills for determining the amount of fuel remaining in a propane tank.

Outdoor barbecue grills are used to cook food outdoors, generally over an open flame. They generally comprise a cooking chamber or firebox that is supported by a cart and has a hood. These grills generally come in gas or charcoal varieties. The gas varieties require a supply of gas as fuel. Tanks of propane gas are most commonly used to provide fuel for gas barbecue grills.

Propane gas tanks used in outdoor barbecue grills typically do not provide any indication of how much gas is left in the tank. This presents a problem when users plan to cook on the gas grill since they have no way of knowing whether they have enough gas in the tank to cook the food they wish to cook. Users are left to guess how much gas is left in the tank and whether that will be sufficient to cook their food.

One approach to this problem is a pressure gauge that is screwed onto the nozzle of the propane tank in order to get a reading of how much gas is left in the tank. However, this approach is problematic for a couple of several reasons. First, these pressure gauges must be removed and re-attached every time the user replaces the propane tank. This constant removal and re-attachment is inconvenient for the user.

An additional problem with a pressure gauge is that the propane tank is usually positioned on a shelf or in a compartment of the cart underneath the grill's firebox. When the compartment has doors, it is difficult to see the propane tank and the attached pressure gauge without opening the doors. After opening the doors, reading the pressure gauge can be inconvenient as the gauge is usually attached directly to the nozzle near the top of the propane tank. In order to view the gauge, users may have to bend over and even perhaps stick their heads under the firebox, which may be hot if the grill is or recently has been in operation. Moreover, reading the gauge may require users to adjust the position of the propane tank position so that the gauge is easier to see. This can be awkward for users because propane tanks are relatively heavy and users may be bent over or kneeling while attempting to adjust the tank's position. These latter concerns may apply even if the grill only has a shelf or an open compartment without doors for the propane tank.

Thus, it can readily be appreciated that there is a need for an outdoor barbecue grill that more conveniently provides an indication to users of how much gas is left in a propane tank. The present invention fulfills this need and provides further related advantages.

### SUMMARY OF THE INVENTION

The present invention resides in a propane tank fuel gauge for use with a barbecue grill that measures the weight of the tank and thereby provides a readily perceived indication of the amount of propane gas remaining therein. In particular, the fuel gauge comprises a base, a tank mount adapted for mounting a propane tank, a spring-loaded support mechanism for supporting the tank mount relative to the base, and a fuel level indicator connected to the support mechanism for providing an indication of the total weight of the tank including the propane gas remaining therein. The fuel gauge may be calibrated to indicate the amount of fuel remaining in the propane tank based on its weight, i.e., to have the fuel level indicator indicate “full” when the propane tank is at its heaviest (i.e., full, or substantially full, of propane fuel), “empty” when the propane tank is at its lightest (i.e., empty, or nearly empty, of propane fuel), and an approximation of the amount of fuel remaining in the tank when its weight falls between these two extremes as fuel is used to operate the barbecue grill.

In a presently preferred embodiment, by way of example, the tank mount may comprise a mounting frame that is sized and configured to receive the propane tank therein. The tank mounting frame may include a clamp mechanism to ensure that the tank is held generally upright in a secure and stable manner in the tank mounting frame on or near an upper surface of the base. The support mechanism for supporting the tank mounting frame is configured to allow movement of the tank mounting frame relative to the base. The support mechanism may include a spring mechanism interposed between the tank mounting frame and the base to help support the tank mounting frame and to control its position and movement when a propane tank is mounted therein. The fuel level indicator may comprise a needle, connected (directly or indirectly) to the support mechanism, to provide an indication relative to a marked scale of the position and movement of the tank mounting frame, and thus of the weight of the tank, as fuel is consumed by the grill.

More specifically, in the presently preferred embodiment, the support mechanism pivotally mounts a first side of the tank mounting frame to the base and supports an opposite, second side of the tank mounting frame somewhat above the base by means of a compression spring. The fuel level indicator is in the form of an arm-like member that is pivotally mounted, via a bracket secured within the base, medial the opposite ends of the member. The support mechanism includes a linkage that interconnects the second side of the tank mounting frame, through an opening in the base, to a first end of the fuel level indicator arm within the base. The opposite, second end of the fuel level indicator arm serves as the indicator needle and projects through an opening at the front of the base. When a fuel tank is placed in the tank mounting frame, its weight causes the second side of the tank mounting frame to pivot lower against the compression of the spring, which in turn pushes both the interconnected linkage and the first end of the fuel level indicator arm lower. This causes the fuel indicator arm to pivot and the indicator needle at the second end of the fuel level indicator arm to rise. Conversely, as the grill consumes fuel from the tank, the weight of the tank decreases, which causes the second side of the frame, along with the interconnected linkage and the first end of the fuel level indicator arm, to gradually rise. This, in turn, causes indicator needle to gradually fall, indicating less fuel in the tank.

Advantageously, the propane tank fuel gauge of the present invention can be integrated into a barbecue grill by having the base of the fuel gauge serve as the base of the grill cart that supports the firebox. This allows the user to view the fuel level indicator through the opening in the front of the base without opening the doors (if any) on the propane fuel tank compartment, and without having to bend over, possibly stick one's head under the firebox, or adjust the position of the propane tank position so that a pressure gauge is easier to read. Alternatively, the propane tank fuel gauge of the present invention can be a separate unit that the user places on a shelf of the barbecue or elsewhere near the grill.

Other features and advantages of the invention should become apparent from the following description of the preferred embodiments, taken in conjunction with the accompanying drawings, which illustrate, by way of example, the principles of the invention.

### BRIEF DESCRIPTION OF THE DRAWINGS

A presently preferred embodiment of the invention will now be described, by way of example only, with reference to the following drawings.

FIG. 1 is a perspective view of a barbecue grill with a built-in propane tank fuel gauge and a propane tank mounted thereon, the fuel gauge having a base that also serves as the base of a cart for supporting the grill's firebox, in accordance with the preferred embodiment of the invention.

FIG. 2 is a close-up perspective view of an indicator needle of a fuel lever indicator at the front of the base of the propane tank fuel gauge shown in FIG. 1, the fuel level indicator including an indicator needle projecting through an opening having a marked scale to indicate the fuel level in the propane tank.

FIG. 3A is a close-up perspective view of a propane tank fuel gauge of FIG. 1, shown with the propane tank removed to reveal a tank mounting frame and a support mechanism for the mounting frame.

FIG. 3B is a close-up view of the tank mounting frame and support mechanism of FIG. 3A shown with a propane tank mounted in the mounting frame.

FIG. 4A is a view of the propane tank fuel gauge of FIG. 1 from the bottom of the base, showing a mounting bracket for a spring that supports one side of the tank mounting frame and the fuel gauge indicator arm interconnected by a linkage to the tank mounting frame through an opening in the base.

FIG. 4B is a close-up view of the spring mounting bracket and the fuel gauge indicator arm and linkage shown in FIG. 4A.

FIG. 5 is a perspective view similar to FIG. 3A, with the barbecue grill and base shown in phantom to reveal the entire mechanism of the propane tank fuel gauge.

FIG. 6A is a close-up perspective view of the propane tank fuel gauge without a propane tank in place, the components of the fuel gauge mechanism inside the base shown in phantom in a state causing the fuel gauge indicator needle to indicate “E” for empty.

FIG. 6B is the close-up perspective view similar to FIG. 6A with a full propane tank in place, the components of the fuel gauge mechanism inside the base shown in phantom in a state causing the fuel gauge indicator needle to indicate “F” for full.

### DETAILED DESCRIPTION OF THE PREFERRED EMBODIMENTS

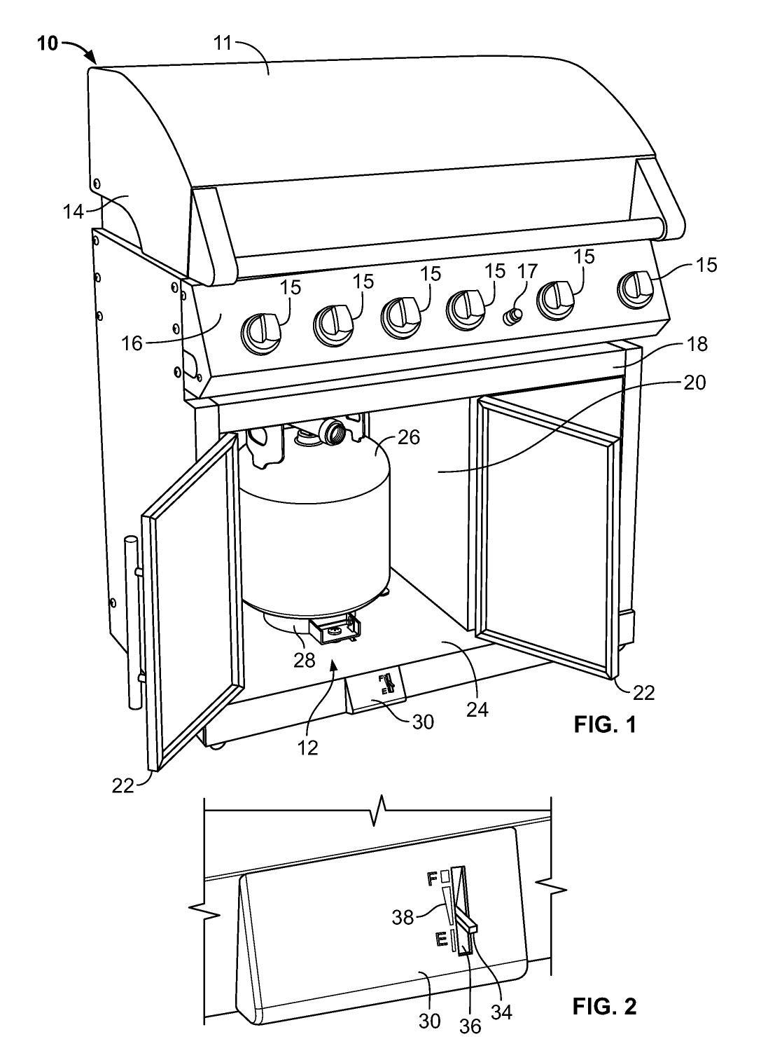

Referring now to the drawings, and particularly to FIG. 1 thereof, there is shown a barbecue grill 10 incorporating a propane tank fuel gauge 12 in accordance with a presently preferred embodiment of the invention. Apart from the fuel gauge, the grill has components that are common to most grills: a firebox 14 containing burners and a grilling surface (not shown); a hood 11 pivotally mounted on top of the firebox; a panel 16 at the front of the firebox with control knobs 15 for controlling gas flow to the burners and an igniter 17 for igniting the burners; and a cart 18 for supporting the firebox. The cart includes an enclosed compartment 20 with a base 22 and doors 21 for holding a propane tank 23.

As shown in FIG. 1, the fuel gauge 12 includes a tank mounting frame 28 to mount the propane tank 26 above the base 24 within the compartment 20. The fuel gauge also includes a fuel level indicator 30 to provide an indication of the amount of fuel in the propane tank. The fuel level indicator is positioned at the front of the base, below the doors 22 to the compartment 20, so that the fuel level indicator is readily viewable from the outside of the barbecue grill 10 regardless of whether the doors are opened or closed.

FIG. 2 provides a close-up view of the fuel level indicator 30. In the preferred embodiment, the fuel level indicator includes an indicator arm 32 (not shown in FIG. 2) having an indicator needle 34 at one end that projects through an opening 36. A marked scale 38 is provided adjacent the opening to correlate the position of the indicator needle with the amount of fuel in the propane tank. As described in detail below, the indicator needle 34 is in an “F” range on the marked scale when a full or partially filled tank is in the tanking mounting frame 28, and moves gradually downward toward an “E” range on the marked scale as fuel in the propane tank is used during operation of the grill.

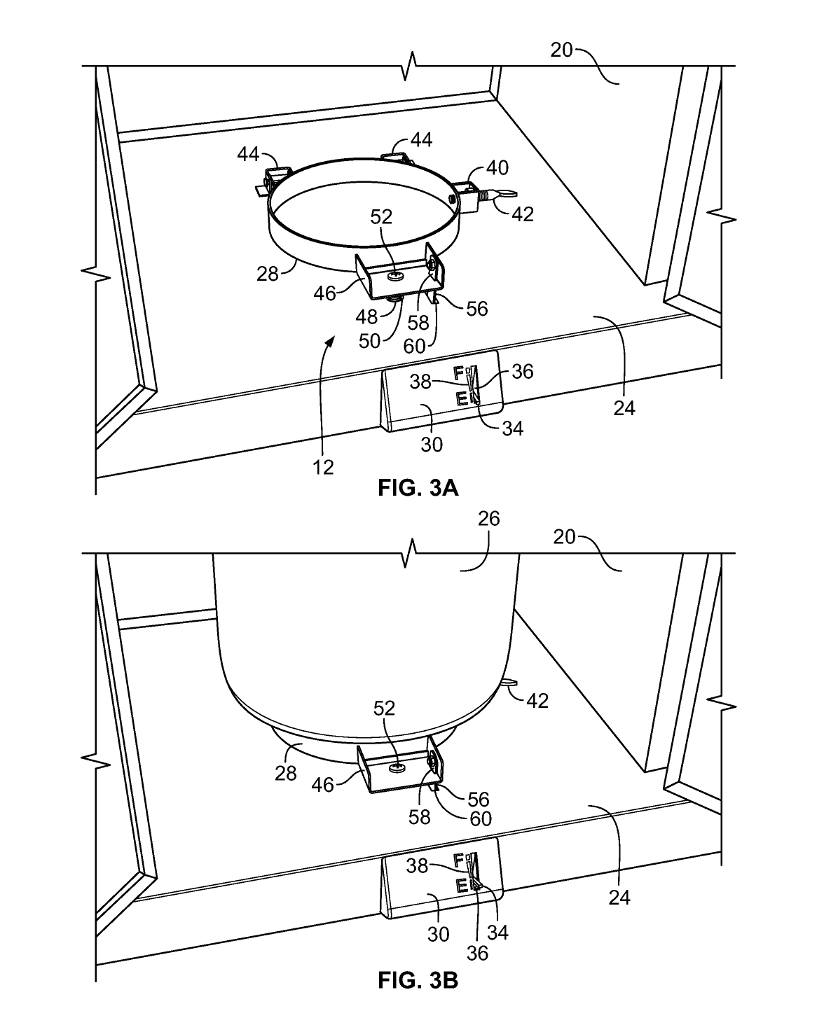

Turning to FIG. 3A, there is provided a close-up view of the fuel gauge 12 as it appears inside the compartment 20 of the grill cart 18 without a propane tank in place. As noted, the fuel gauge 12 includes a tank mounting frame 28 to mount the propane tank 26 above the base 24. The tank mounting frame is essentially a large, heavy collar that is sized to receive with a relatively snug fit the cylindrical base of a conventional propane tank of a pre-designated capacity. The propane tank is held generally upright by the tank mounting frame and can be secured in place by a clamp mechanism 40 having a tightening screw 42 on one side of the mounting frame.

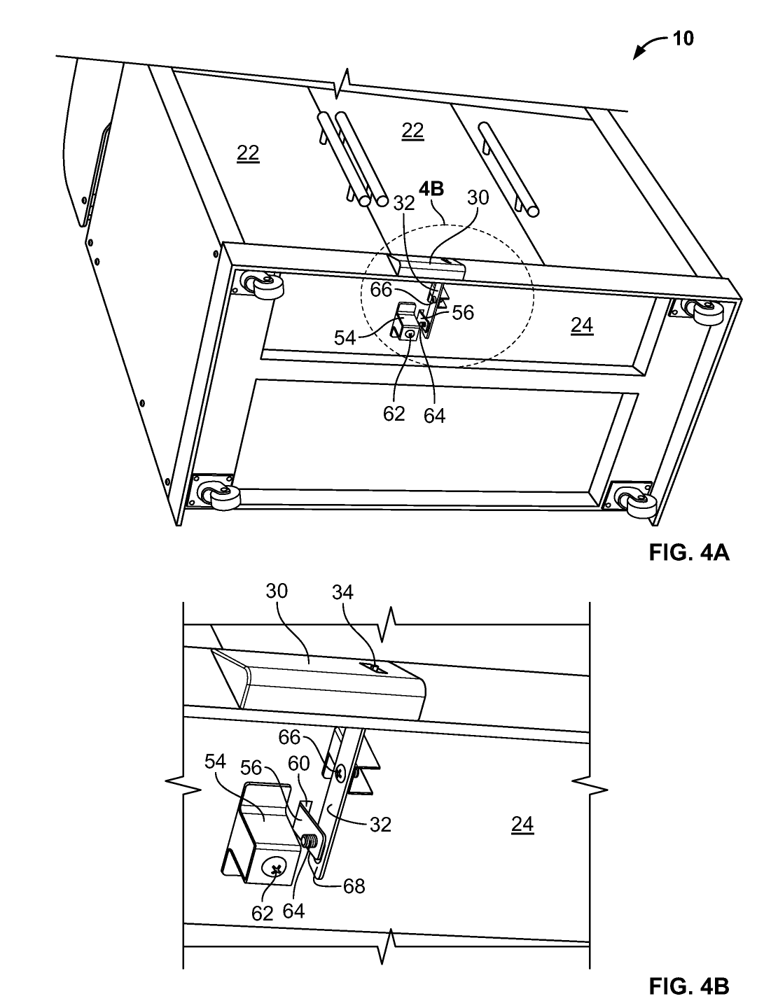

As shown in FIG. 3A, a support mechanism comprising a pair of supports 44 at the rear of the tank mounting frame 28 and a spring-loaded bracket 46 at front of the mounting frame are provided to support the mounting frame above the base 24. In this regard, the rear supports are fixedly secured to the top of the base, and the tank mounting frame is pivotally attached to the supports. The spring-loaded bracket is fixedly secured to the front of the tank mounting frame. The support mechanism further includes a compression spring 48 that extends through an opening 50 in the top of the base and supports the spring-loaded bracket from underneath. The top of the spring is held in place on the spring-loaded bracket by a fastener 52, and the bottom of the spring is fixedly supported by a spring-support bracket 54 (not shown in FIG. 3A) from within the base. A first end 58 of a linkage 56 is pivotally connected to one side of the spring-loaded bracket and extends through another opening 60 in the top of the base. It will be described below in connection with FIGS. 4A-4B.

As can be seen in FIG. 3A, when there is no load on the tank mounting frame 28 due to the absence of a propane tank, the front side of the mounting frame (along with the spring-loaded bracket 46) pivots upward a relatively slight amount above the rear of the mounting frame due to the force of the spring 48. In the preferred embodiment, this angle is about 6 degrees. In this state, the indicator needle 34 of the fuel level indicator 30 is at the bottom of its travel in the opening 36 of the fuel level indicator 30.

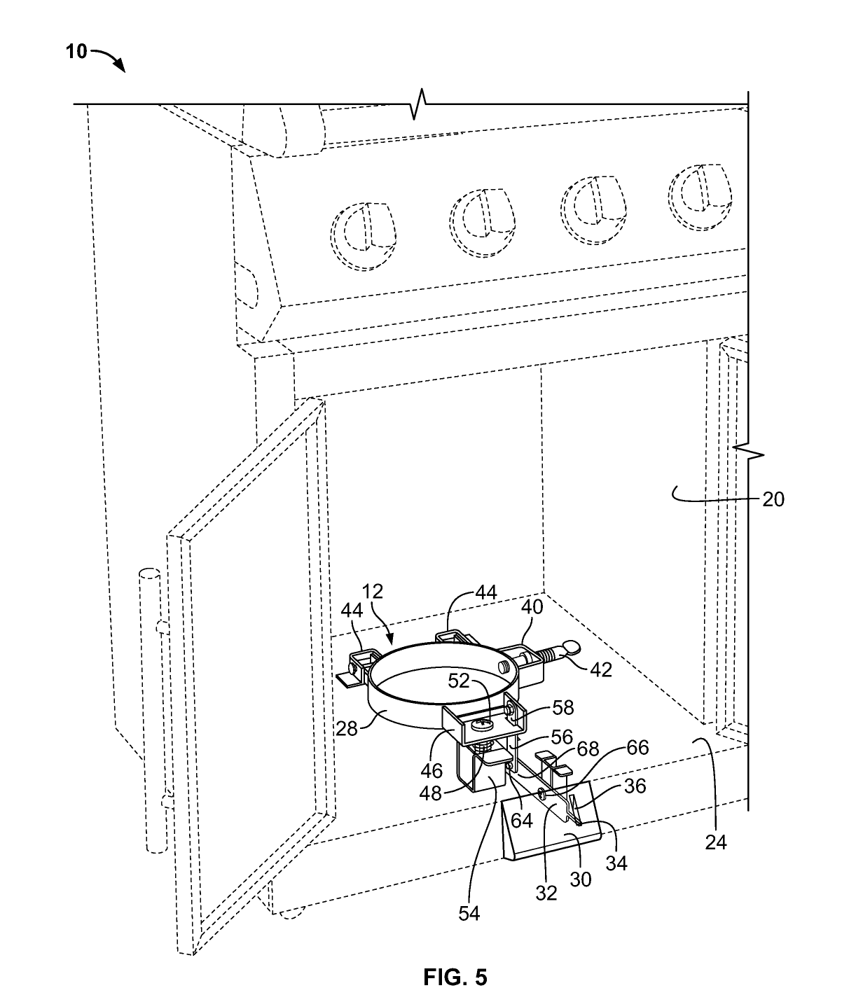

A typical propane tank may weigh about 20 lbs. empty. Referring to FIG. 3B, when an empty or nearly empty propane tank 26 is placed in the mounting frame 28, its weight is sufficient to cause the front of the mounting frame 46 to pivot down slightly against the force of the spring 48. This causes the indicator needle 34 to rise, as discussed in connection with FIGS. 4A-4B and 5 below. However, the indicator needle rises only slightly in this state, such that it stays within a range marked “E” on the marked scale 38. The same propane tank may weigh about 40 lbs. when full or nearly full of propane. The added weight of propane in the tank causes the front of the mounting frame to pivot downward further against the force of the spring 48. This causes the indicator needle to rise into a range marked “F” on the marked scale, depending on the fullness of the tank. Preferably, for a full tank, the front of the tank mounting frame pivots downward such that it is at about the same height as the rear of the mounting frame (i.e., approximately level) in this state, causing the indicator needle to rise to the top of its travel in the opening 36 of the fuel level indicator 30.

The mechanism by which the pivoting of the tank mounting frame 28 causes the indicator needle 34 of the fuel level indicator 30 to move will now be described with reference to FIGS. 4A-4B and 5. FIGS. 4A-4B illustrate the bottom side of the base 24 where both the spring 48 and the linkage 56 pass through their respective openings 50 and 60. The phantom view of FIG. 5, illustrates the entire fuel gauge mechanism. As shown, the spring-support bracket 54 is fixedly attached to the base, underneath the spring opening 50. A fastener 62 holds the bottom of the spring (not shown) in place in the spring-support bracket. The linkage 56 extends downward from its first end 58, through the linkage opening, where an opposite, second end of the linkage is pivotally connected by a fastener 64 to a first end 68 of the indicator arm 32. As previously noted, the opposite, second end of the indicator arm serves as the indicator needle 34. Medial of its two ends the linkage is pivotally connected by a fastener 66 to a fixed bracket secured to the underside of the base. The indicator arm thus serves as a lever arm, with fastener 66 as its fulcrum.

In operation, when the front side of the tank mounting frame 46 lowers against the force of the spring 48 due to the weight of a filled propane tank in the tank mounting frame 28, the linkage 56 pushes down on the first end 68 of the indicator arm 32, causing it to pivot on the linkage bracket 66 and forcing indicator needle 34 to rise. Conversely, as barbecue grill uses propane fuel during operation and the tank weight decreases, the front side of the tank mounting frame 28 rises due to the force of the spring, lifting the first end of the indicator arm. This causes the indicator arm to pivot in the opposite direction on the linkage bracket and forces the indicator needle to fall. The indicator needle thus provides the user with an indication of the propane tank's current fuel level.

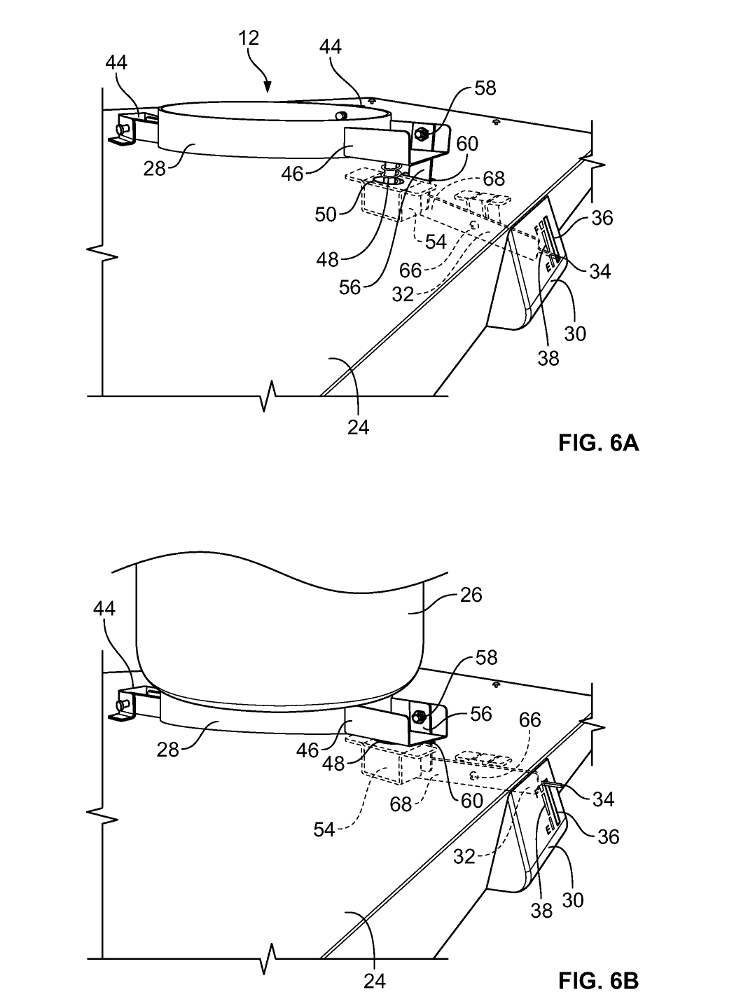

FIGS. 6A and 6B provide a close-up side view of the fuel gauge mechanism 12. In FIG. 6A, the spring 48 is more clearly visible. When there is no load on the tank mounting frame 28, the spring 48 is not compressed and the front side 46 of the tank mounting frame is raised with the indicator needle 34 at the bottom of its travel in “E” range. As shown in FIG. 6B, when a full propane tank 26 is positioned in the tank mounting frame, the weight of the tank compresses the spring 48, forcing the linkage 56 downward and causing the needle 34 to rise to the top of its travel in the “F” range. As the propane fuel is used, the weight of the propane tank 26 will decrease, allowing the spring to decompress, gradually pulling the linkage 56 upward and causing the indicator needle to fall.

Although the invention has been disclosed with reference only to the presently preferred embodiments, those of ordinary skill in the art will appreciate that various modifications can be made without departing from the invention. Accordingly, the invention is defined only by the following claims.

What is claimed is:

1. A propane tank fuel gauge comprising:
a base;
a tank mount supported by the base for mounting a propane tank, the tank mount comprising a spring-loaded support for measuring the weight of a propane tank mounted in the tank mount, including the propane gas contained therein; and
a fuel level indicator in communication with the tank mount.

2. The propane tank fuel gauge of claim 1, wherein the fuel level indicator provides an indication of how much propane gas is contained in the propane tank based on the weight of the propane tank.

3. The propane tank fuel gauge of claim 2, wherein the spring-loaded support comprises one or more springs, the one or more springs being characterized by a compression tension such that
the one or more springs will remain substantially uncompressed until a minimum weight is exerted on the one or more springs, and
the one or more springs will become substantially fully compressed when a maximum weight is exerted on the one or more springs.

4. The propane tank fuel gauge of claim 3, wherein the minimum weight is approximately the weight of a standard propane tank when it is empty.

5. The propane tank fuel gauge of claim 4, wherein the minimum weight is approximately 20 pounds.

6. The propane tank fuel gauge of claim 3, wherein the maximum weight is approximately the weight of a standard propane tank when it is full.

7. The propane tank fuel gauge of claim 6, wherein the maximum weight is approximately 40 pounds.

8. The propane tank fuel gauge of claim 3, wherein the propane tank fuel gauge is calibrated to indicate the amount of fuel remaining in the propane tank by
having the fuel level indicator indicate “full” when a propane tank having a weight greater than the maximum weight is on the tank mount,
having the fuel level indicator indicate “empty” when a propane tank having a weight less than or equal to the minimum weight is on the tank mount, and
having the fuel level indicator approximate the amount of propane gas remaining in the propane tank when the propane tank's weight falls between the maximum weight and minimum weight.

9. The propane tank fuel gauge of claim 8, wherein the fuel level indicator comprises a needle that is in communication with the spring-loaded support such that compression of the one or more springs causes movement of the needle, the position of the needle providing an indication of how much propane gas is contained in the propane tank.

10. The propane tank fuel gauge of claim 8, wherein the spring-loaded support is configured to allow movement of the tank mount relative to the base.

11. The propane tank fuel gauge of claim 10, wherein compression of the one or more springs causes movement of the tank mount relative to the base.

12. The propane tank fuel gauge of claim 11, wherein the fuel level indicator comprises a needle that is in communication with the tank mount such that movement of the tank mount relative to the base causes movement of the needle, the position of the needle providing an indication of how much propane gas is contained in the propane tank.

13. The propane tank fuel gauge of claim 12, wherein
the tank mount is pivotably mounted to the base such that the tank mount has a fixed end and a pivoting end, and
the spring-loaded support is positioned proximate and supports the pivoting end, such that compression of the one or more springs in the spring-loaded support causes the pivoting end to pivot relative to the base.

14. The propane tank fuel gauge of claim 1, wherein the tank mount comprises a mounting frame that is sized and configured to receive a propane tank.

15. The propane tank fuel gauge of claim 14, wherein the mounting frame comprises a clamp for securing a propane tank to the mounting frame.

16. A grill comprising:
a firebox;
a plurality of burners housed within the firebox; and
a propane tank fuel gauge proximate the plurality of burners such that a propane tank mounted on the propane tank fuel gauge may be connected to and provide fuel to the plurality of burners, the propane tank fuel gauge comprising
a base,
a tank mount supported by the base for mounting a propane tank, the tank mount comprising a spring-loaded support for measuring the weight of a propane tank mounted in the tank mount, including the propane gas contained therein, and
a fuel level indicator in communication with the tank mount for providing an indication of the weight of the propane tank measured by the spring-loaded support.

17. The grill of claim 16, wherein the fuel level indicator provides an indication of how much propane gas is contained in the propane tank based on the weight of the propane tank.

18. The grill of claim 17, wherein the spring-loaded support comprises one or more springs, the one or more springs being characterized by a compression tension such that
the one or more springs will remain substantially uncompressed until a minimum weight is exerted on the one or more springs, and
the one or more springs will become substantially fully compressed when a maximum weight is exerted on the one or more springs.

19. The grill of claim 18, wherein the minimum weight is approximately the weight of a standard propane tank when it is empty.

20. The grill of claim 19, wherein the minimum weight is approximately 20 pounds.

21. The grill of claim 18, wherein the maximum weight is approximately the weight of a standard propane tank when it is full.

22. The grill of claim 21, wherein the maximum weight is approximately 40 pounds.

23. The grill of claim 18, wherein the propane tank fuel gauge is calibrated to indicate the amount of fuel remaining in the propane tank based on its weight by
having the fuel level indicator indicate “full” when a propane tank having a weight greater than or equal to the maximum weight is placed on the tank mount,
having the fuel level indicator indicate “empty” when a propane tank having a weight less than or equal to the minimum weight is placed on the tank mount, and
having the fuel level indicator approximate the amount of propane gas remaining in the propane tank when the propane tank's weight falls between the maximum weight and minimum weight.

24. The grill of claim 23, wherein the fuel level indicator comprises a needle that is in communication with the spring-loaded support such that compression of the one or more springs causes movement of the needle to provide an indication of how much propane gas is contained in the propane tank.

25. The grill of claim 23, wherein the spring-loaded support is configured to allow movement of the tank mount relative to the base.

26. The grill of claim 25, wherein compression of the one or more springs causes movement of the tank mount relative to the base.

27. The grill of claim 26, wherein the fuel level indicator comprises a needle that is in communication with the tank mount such that movement of the tank mount relative to the base causes movement of the needle to provide an indication of how much propane gas is contained in the propane tank.

28. The grill of claim 27, wherein
the tank mount is pivotably mounted to the base such that the tank mount has a fixed end and a pivoting end, and
the spring-loaded support is positioned proximate to and supports the pivoting end, such that compression of the one or more springs in the spring-loaded support causes the pivoting end to pivot relative to the base.

29. The grill of claim 16, wherein the tank mount comprises a mounting frame that is sized and configured to receive a propane tank.

30. The grill of claim 29, wherein the mounting frame comprises a clamp for securing a propane tank to the mounting frame.

31. The grill of claim 16 further comprising a housing for housing a propane tank, wherein the propane tank fuel gauge is a part of the housing.

32. The grill of claim 31, wherein the fuel level indicator is positioned outside the housing such that a user is able to see the fuel level indicator without looking within the housing.
